(19) United States
(12) Patent Application Publication
(10) Pub. No.: US 2015/0217900 A1
(43) Pub. Date: Aug. 6, 2015

(54) Extendable and collapsible container

(71) Applicant: Eric Poulin, Pierrefonds (CA)

(72) Inventor: Eric Poulin, Pierrefonds (CA)

(21) Appl. No.: 14/172,002

(22) Filed: Feb. 4, 2014

(51) Int. Cl. B65D 21/08; A61J 9/00

(52) U.S. Cl. CPC B65D 21/086; A61J 9/005

(57) ABSTRACT

An improved extendable and collapsible container has a plurality of telescoping sleeves adapted to interlock with one another to form a desired volume. A base member attached to a bottom most sleeve and adapted to house the sleeves when the container is collapsed, and adapted to form a base of the container when the container is extended. A removable cap member attached to a top most sleeve and adapted to enclose the volume when the container is extended, the cap member includes a closable opening therethrough adapted to allow a substance to pass from the volume inside the container outward therefrom when desired. A sleeve locking mechanism adapted to lock the sleeves in respective positions when a desired volume is formed and unlock the sleeves from their respective positions when it is desired to collapse the container.

This application claims priority based on request GB1302052.4 filed Feb. 5, 2013

### FIELD OF THE INVENTION

The present invention relates generally to collapsible containers but more particularly to a multi-purpose extendable and collapsible container with a hidden locking mechanism.

### BACKGROUND OF THE INVENTION

There exist a variety of telescopic, retractable and extendable containers for a multitude of uses. The majority of them have a primary intent to save space, rigidity being a secondary factor. Many of them do not offer an airtight solution. There hence exists a need for an extendable and collapsible container that offers rigidity and an airtight solution to users.

### SUMMARY OF THE INVENTION

In view of the foregoing disadvantages inherent in the known devices now present in the prior art, the present invention, which will be described subsequently in greater detail, is to provide objects and advantages which are:

To provide for an improved extendable and collapsible container with a hidden locking mechanism allowing it to be locked at a desired volume. It is another advantage to provide a locking mechanism allows a lid to be pressed on or pulled off without compromising the rigidity of the container.

It is a further advantage of this invention to have sleeves with interlocking lips offering maximum water and airtight qualities.

In order to do so, the invention comprises a plurality of telescoping sleeves adapted to interlock with one another to form a desired volume. A base member attached to a bottom most sleeve and adapted to house the sleeves when the container is collapsed, and adapted to form a base of the container when the container is extended. A removable cap member attached to a top most sleeve and adapted to enclose the volume when the container is extended, the cap member includes a closable opening therethrough adapted to allow a substance to pass from the volume inside the container outward therefrom when desired. A sleeve locking mechanism adapted to lock the sleeves in respective positions when a desired volume is formed and unlock the sleeves from their respective positions when it is desired to collapse the container.

The improved extendable and collapsible container has the sleeve locking mechanism housed within an interior of the volume formed by the sleeves.

The sleeve locking mechanism includes a control knob extending through the base member and outside the volume and adapted to allow the sleeves to be locked and unlocked therefrom.

The cap member further includes a spout portion attached to the closable opening and adapted to allow a smoother flow of the substance out of the container. The spout further includes a stopper member adapted to selectively open and close the spout member.

The cap member further includes a nursing nipple attached to the closable opening, and a pressure valve attached to the closable opening and adapted to allow the substance to pass therethrough as the volume is reduced thereby causing an increase in internal pressure and thereby forcing a desired amount of the substance out through the valve.

The sleeve locking mechanism further includes a plurality of telescoping cylinders, each cylinder respectively attached to a telescoping sleeve. A gear mechanism rotatably connected to an internal surface of the base member, mechanically connected to a lowermost cylinder, and rigidly connected to the control knob, such that the control knob is adapted to rotate the cylinders in either of two directions, one direction to lock the sleeves in place and an opposite direction to unlock the sleeves and allow the container to be collapsed.

In one embodiment, the sleeve locking mechanism is formed as a straight bayonet type locking mechanism, wherein each the sleeve includes a series of bayonets on an outer surface thereof that releasably attached to an adjacent sleeve having a series of bayonets on an interior surface thereof, thereby attaching or releasing from an adjacent sleeve by a twisting motion of outer surfaces of the sleeves by a user in one direction to attach and an opposite direction to release the sleeves from one another and allow the container to be collapsed.

In an alternate embodiment, the sleeve locking mechanism is formed as a helicoidal bayonet type locking mechanism, wherein each the sleeve includes a series of bayonets on an outer surface thereof that releasably attach to a bayonet catch on the inner surface of an adjacent sleeve, thereby attaching or releasing from an adjacent sleeve by a twisting motion of outer surfaces of the sleeves by a user in one direction to attach and an opposite direction to release the sleeves from one another and allow the container to be collapsed.

In yet another embodiment, the sleeve locking mechanism is formed as a ratchet type locking mechanism, wherein each the sleeve includes a series of first ratchet teeth on an outer surface thereof that releasably attach to a series of second ratchet teeth of an adjacent sleeve on an inner surface thereof, such that adjacent sleeves can be connected at various locations to one another via a linear motion of the sleeves by a user in one direction to extend the sleeves and form the volume and an opposite direction to collapse the container.

The sleeve locking mechanism is formed as a lip type locking mechanism, wherein each the sleeve includes an upper lip and a lower lip thereon, wherein each the upper lip releasably attaches to a lower lip of an adjacent sleeve, such that adjacent sleeves can be releasably connected by a user applying force to the sleeves in one linear direction to extend the sleeves and connect respective lips and form the volume and an opposite linear direction to disconnect the respective lips and collapse the container.

The improved extendable and collapsible container can be of varying shapes such as rectangular or cylindrical and is formed from a material chosen from a list of materials comprising steel, aluminum, and plastic.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1a-b Side view of the invention extended and isometric view of invention collapsed.

FIGS. 2a-b Isometric view of invention as a baby bottle and as a wine flask.

FIGS. 3a-b Isometric view of the base of the invention and cutaway view of cylinder type locking mechanism.

FIGS. 4a-b Cutaway view of interlocking sleeves extended and collapsed.

FIGS. 5a-b Cutaway isometric views of interlocking sleeves with teeth locking mechanism in fully extended position.

FIGS. 6a-b-c Side cutaway view of base valve, cutaway perspective view of cylinder type locking mechanism and bottom perspective view of lock control knob.

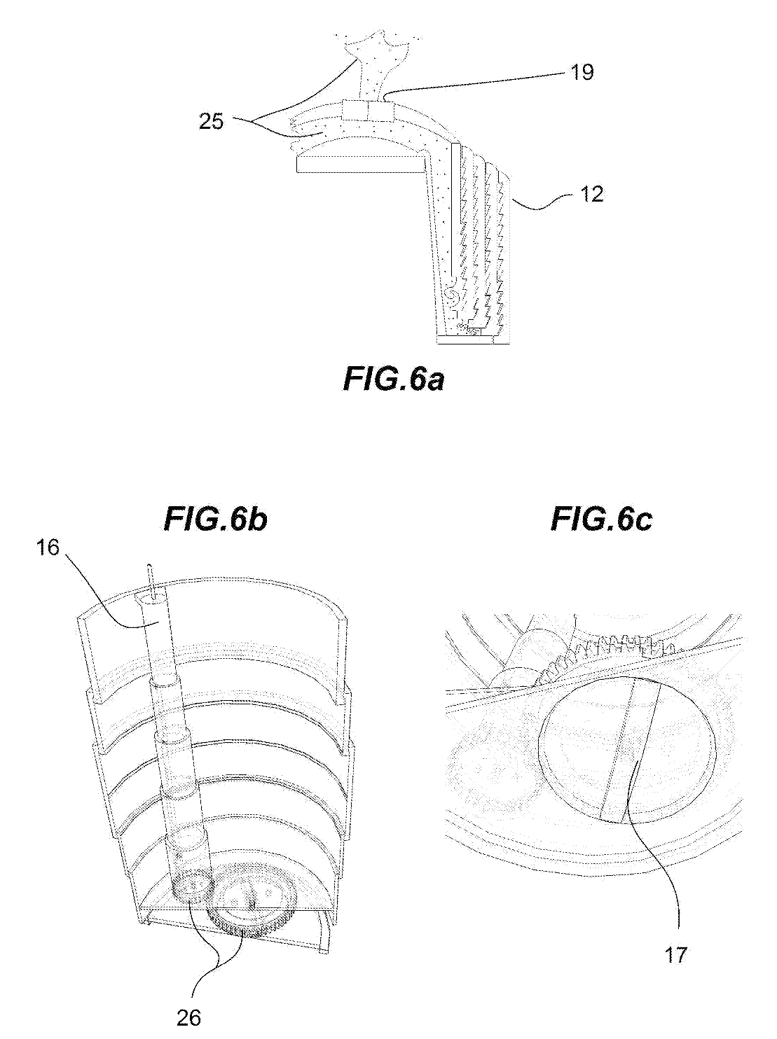

FIGS. 7a-b-c Partial view of straight bayonet type locking connection, exploded view of straight bayonet type locking connection and side cutaway view of helicoidal bayonet type locking connection.

### DETAILED DESCRIPTION OF THE PREFERRED EMBODIMENT

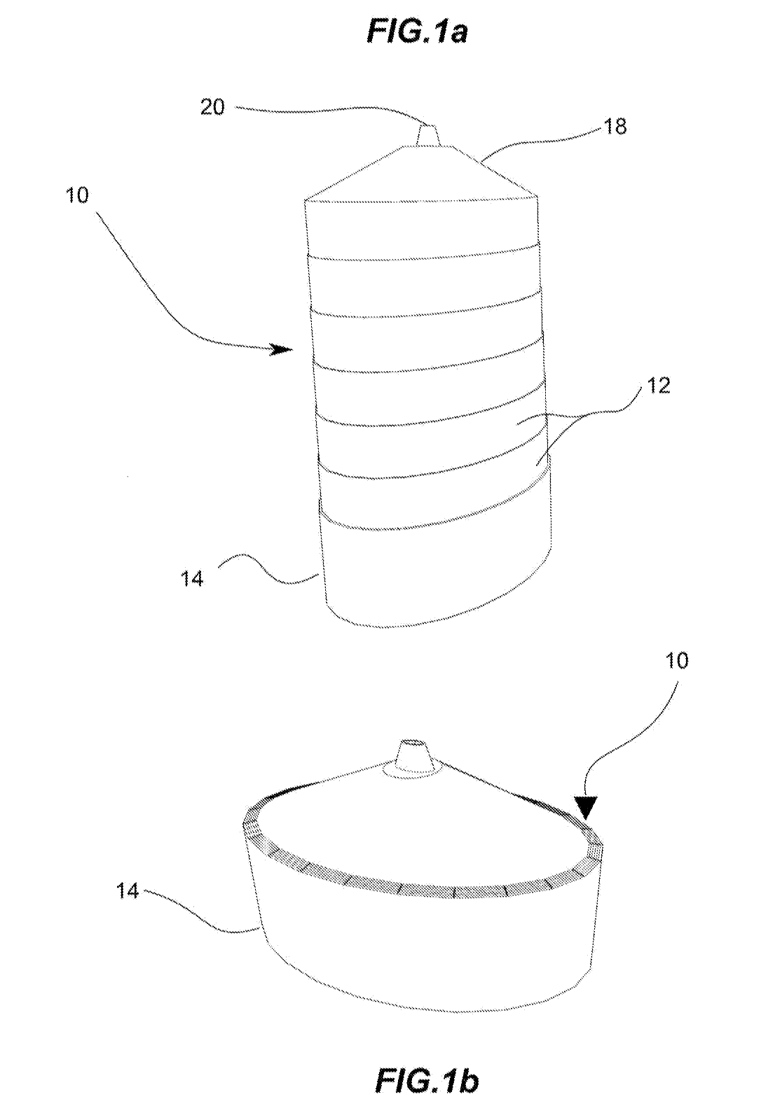

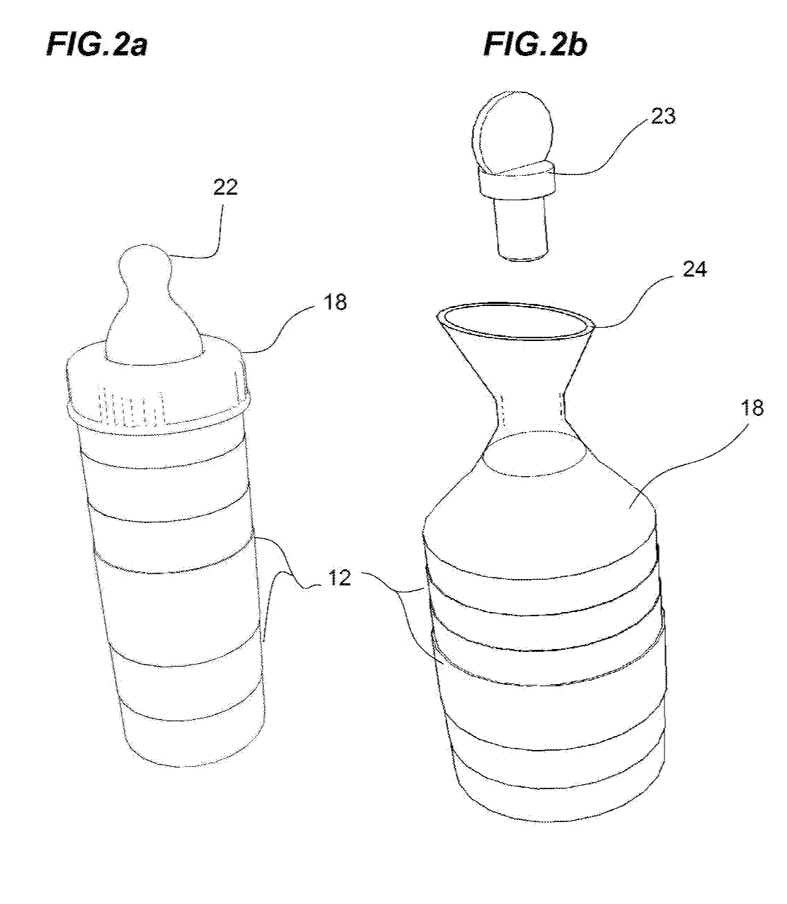

An improved extendable and collapsible container (10) comprising of telescopic sleeves (12) that interlock when extended and having hidden cylinders (16) that also interlock such that a knob (17) provided on the base (14) of the container (10) be turned to lock the hidden cylinders (16) which in turn lock the sleeves (12) in place once a desired volume is attained. A cap member (18), includes a closable opening (21), and fits on top of the container (10) and can have a plurality of functions such as a spout (20) as seen in FIG. 1a or a nursing nipple (22) or a wine spout (24) with stopper (23) as in FIG. 2a & FIG. 2b.

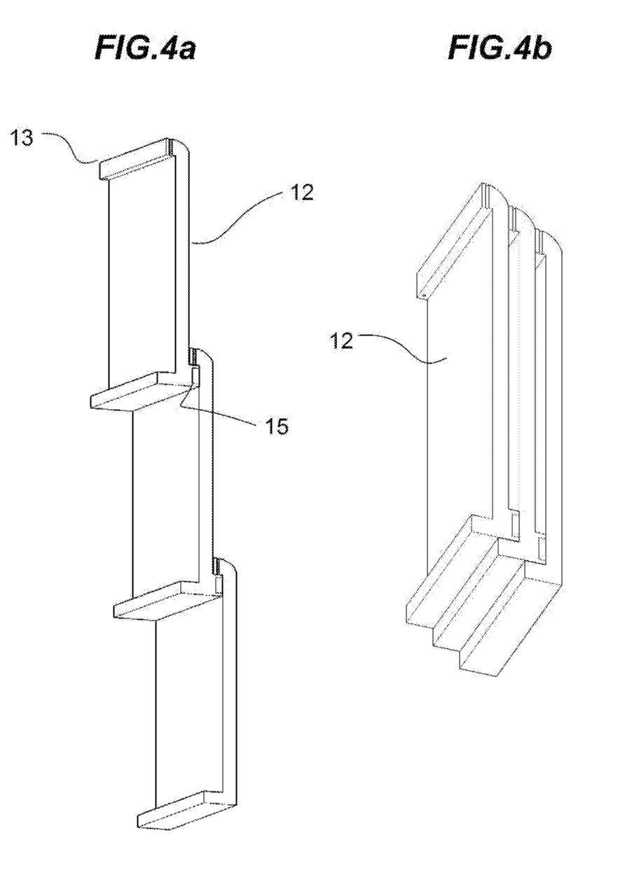

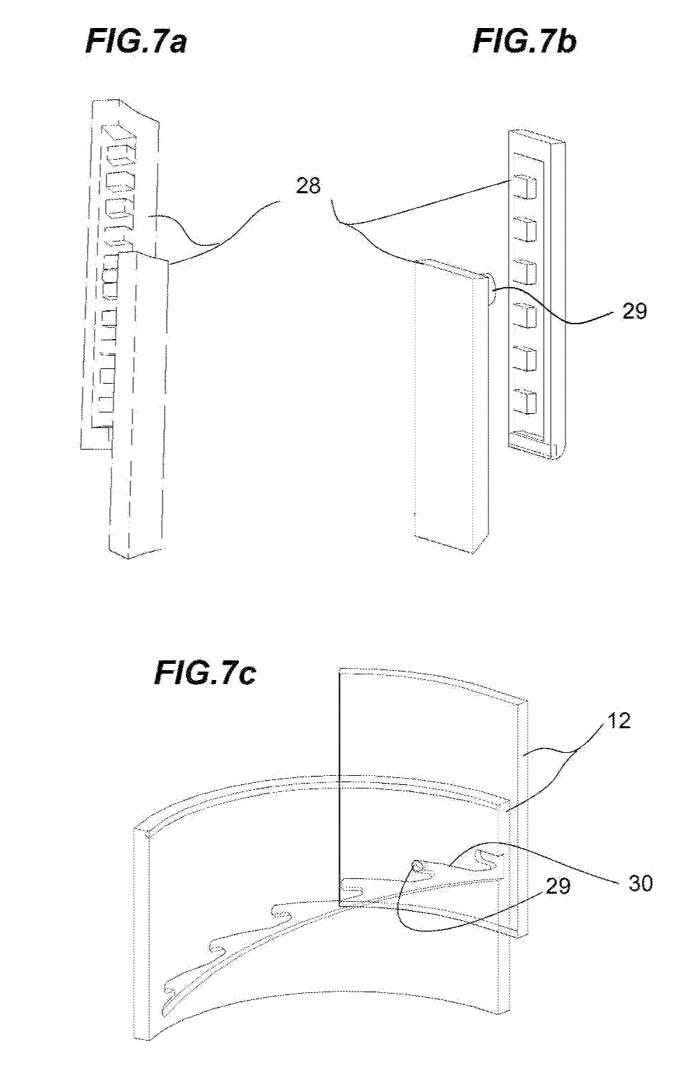

The sleeves (12) interlock when two lip types interlock, a top lip (13) and a bottom lip (15) fit into one another as seen in FIG. 4a. In an alternate embodiment, the sleeves (12) are locked using a straight bayonet type (28) configuration interacting with a bayonet catch (29) in FIG. 7a & FIG. 7b or a helicoidal bayonet type (30) configuration (as seen in FIG. 7c) by twisting the sleeves in different directions, one way to lock and the opposite way to unlock. The sleeves (12) are thicker where they interlock with the aforementioned locking means.

The container (10) with hidden cylinders (16) lock together when the knob (17) provided on its base (14) is turned in one direction. A gearing mechanism (26) allows the knob (17) to control the hidden cylinders (16) thereby locking or unlocking the sleeves (12).

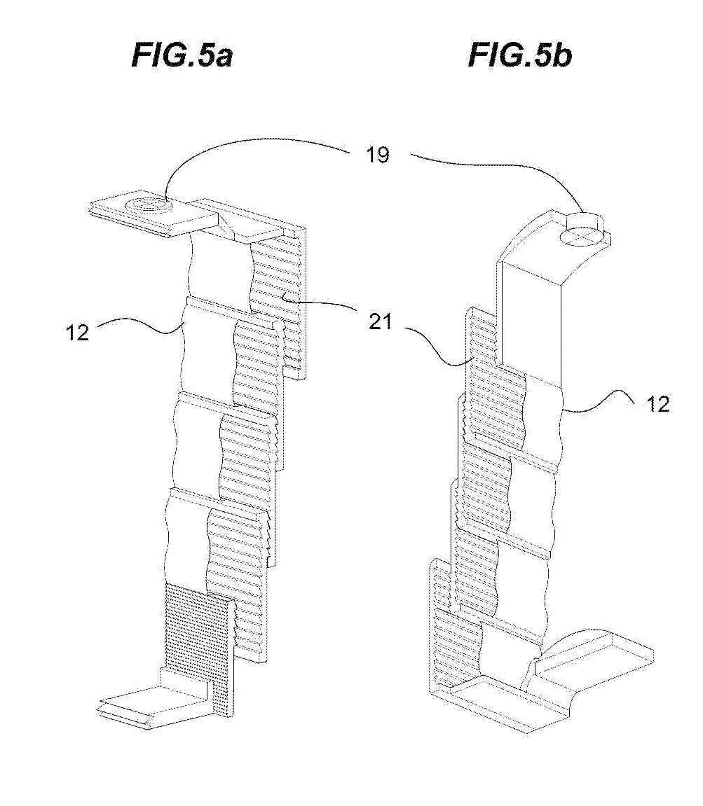

An alternate embodiment (FIGS. 5a & 5b) shows a ratchet type locking mechanism (21). The cap member (18) further includes a pressure valve (19) to allow air to escape the container (10) when it is collapsed into a smaller volume.

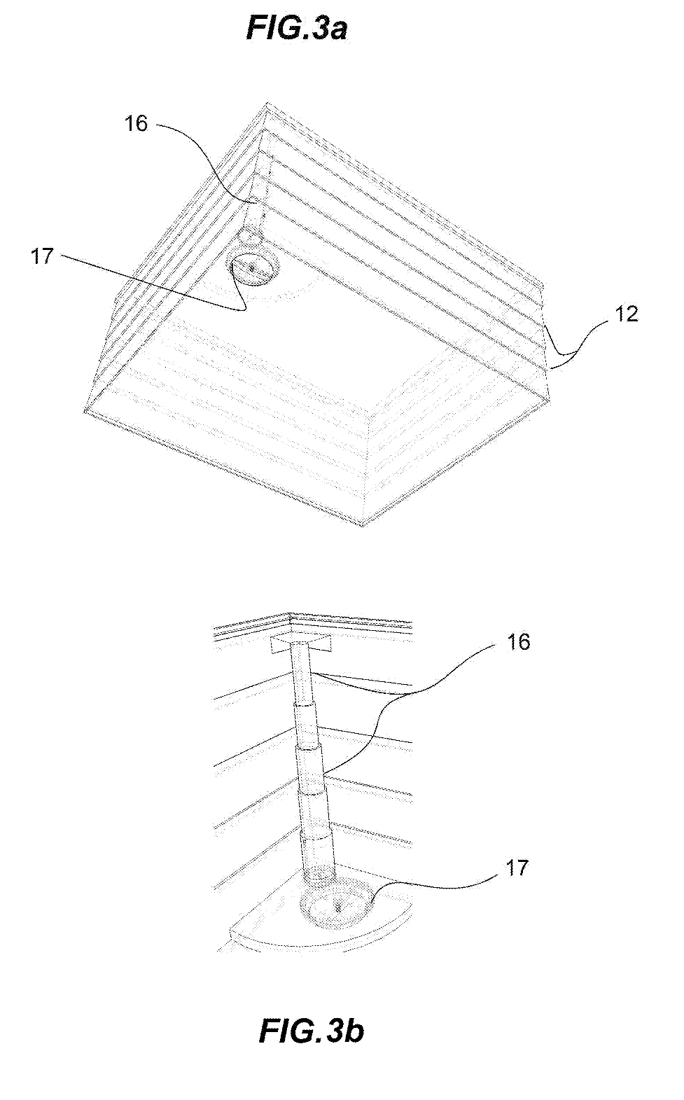

FIG. 3a shows the invention (10) in the form of a receptacle for storing semi solid contents (not shown).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. An improved extendable and collapsible container comprising a plurality of telescoping sleeves adapted to interlock with one another to form a desired volume; a base member attached to a bottom most sleeve and adapted to house said sleeves when said container is collapsed, and adapted to form a base of said container when said container is extended; a removable cap member attached to a top most sleeve and adapted to enclose said volume when said container is extended, said cap member including a closable opening therethrough adapted to allow a substance to pass from said volume inside said container outward therefrom when desired; and a sleeve locking mechanism adapted to lock said sleeves in respective positions when a desired volume is formed and unlock said sleeves from their respective positions when it is desired to collapse said container.

2. The improved extendable and collapsible container of claim 1, wherein said sleeve locking mechanism is housed within an interior of said volume formed by said sleeves.

3. The improved extendable and collapsible container of claim 1, wherein said sleeve locking mechanism including a control knob extending through said base member and outside said volume and adapted to allow said sleeves to be locked and unlocked therefrom.

4. The improved extendable and collapsible container of claim 1, wherein said cap member further includes a spout portion attached to said closable opening and adapted to allow a smoother flow of said substance out of said container.

5. The improved extendable and collapsible container of claim 4, wherein said spout further includes a stopper member adapted to selectively open and close said spout member.

6. The improved extendable and collapsible container of claim 1, wherein said cap member further includes a nursing nipple attached to said closable opening.

7. The improved extendable and collapsible container of claim 1, wherein said cap member further includes a pressure valve attached to said closable opening and adapted to allow said substance to pass therethrough as said volume is reduced thereby causing an increase in internal pressure and thereby forcing a desired amount of said substance out through said valve.

8. The improved extendable and collapsible container of claim 3, wherein said sleeve locking mechanism further includes a plurality of telescoping cylinders, each cylinder respectively attached to a telescoping sleeve; a gear mechanism rotatably connected to an internal surface of said base member, mechanically connected to a lowermost cylinder, and rigidly connected to said control knob, such that said control knob is adapted to rotate said cylinders in either of two directions, one direction to lock said sleeves in place and an opposite direction to unlock said sleeves and allow said container to be collapsed.

9. The improved extendable and collapsible container of claim 2, wherein said sleeve locking mechanism is formed as a straight bayonet type locking mechanism, wherein each said sleeve includes a series of bayonets on an outer surface thereof that releasably attached to an adjacent sleeve having a series of bayonets on an interior surface thereof, thereby attaching or releasing from an adjacent sleeve by a twisting motion of outer surfaces of said sleeves by a user in one direction to attach and an opposite direction to release said sleeves from one another and allow said container to be collapsed.

10. The improved extendable and collapsible container of claim 2, wherein said sleeve locking mechanism is formed as a helicoidal bayonet type locking mechanism, wherein each said sleeve includes a series of bayonets on an outer surface thereof that releasably attach to a bayonet catch on the inner surface of an adjacent sleeve, thereby attaching or releasing from an adjacent sleeve by a twisting motion of outer surfaces of said sleeves by a user in one direction to attach and an opposite direction to release said sleeves from one another and allow said container to be collapsed.

11. The improved extendable and collapsible container of claim 2, wherein said sleeve locking mechanism is formed as a ratchet type locking mechanism, wherein each said sleeve includes a series of first ratchet teeth on an outer surface thereof that releasably attach to a series of second ratchet teeth of an adjacent sleeve on an inner surface thereof, such that adjacent sleeves can be connected at various locations to one another via a linear motion of said sleeves by a user in one direction to extend said sleeves and form said volume and an opposite direction to collapse said container.

12. The improved extendable and collapsible container of claim 2, wherein said sleeve locking mechanism is formed as a lip type locking mechanism, wherein each said sleeve includes an upper lip and a lower lip thereon, wherein each said upper lip releasably attaches to a lower lip of an adjacent sleeve, such that adjacent sleeves can be releasably connected by a user applying force to said sleeves in one linear direction to extend said sleeves and connect respective lips and form said volume and an opposite linear direction to disconnect said respective lips and collapse said container.

13. The improved extendable and collapsible container of claim 1, wherein said container is formed in a rectangular shape.

14. The improved extendable and collapsible container of claim 1, wherein said container is formed in a cylindrical shape.

15. The improved extendable and collapsible container of claim 1, wherein said container is formed from a material chosen from a list of materials comprising steel, aluminum, and plastic.
